(19) United States
(12) Patent Application Publication
(10) Pub. No.: US 2013/0192539 A1
(43) Pub. Date: Aug. 1, 2013

(54) NO-SLACK LENGTH-LIMITED ELASTIC LEASH

(71) Applicants: Allen Woodruff, Lake Mary, FL (US); Han Woodruff, Lake Mary, FL (US)

(72) Inventors: Allen Woodruff, Lake Mary, FL (US); Han Woodruff, Lake Mary, FL (US)

(21) Appl. No.: 13/566,862

(22) Filed: Aug. 3, 2012

Related U.S. Application Data
(60) Provisional application No. 61/514,671, filed on Aug. 3, 2011.

(51) Int. Cl. A01K 27/00

(52) U.S. Cl. CPC A01K 27/003
USPC 119/798

(57) ABSTRACT

A leash has a first end for gripping and a second end for securing to an animal, a length of elastic material, and a length of inelastic material including first and second portions. The length of elastic material and length of inelastic material are configured so that application of tensile force to the first or second end of the leash extends the length of elastic material. Extension of the length of elastic material causes the first portion of the length of inelastic material to lengthen and the second portion of the length of inelastic material to correspondingly shorten. Contraction of the length of elastic material causes the second portion of the length of inelastic material to lengthen and the first portion of the inelastic material to correspondingly shorten, preventing slack in the leash upon sudden deapplication of a tensile force.

This application claims priority to U.S. provisional patent application No. 61/514,671, filed Aug. 3, 2011, which is incorporated by reference herein in its entirety.

### FIELD OF THE INVENTION

The present invention relates generally to an animal leash.

### BACKGROUND

Traditional animal leashes do not remain taut during use. This causes several problems. First, a traditional leash may cause strain on a user's arm and shoulder when an animal sprints unexpectedly, causing the leash to transition from a slacked leash to a taut leash suddenly. Additionally, this action may cause strain on the animal, especially if the leash is connected to a collar around the animal's neck.

Second, a traditional leash that does not always remain taut increases the likelihood of the user stepping on the slacked leash, possibly leading to injury. Furthermore, a leash with slack has a tendency to wrap around the attached animal or user of the leash, causing either to trip or stumble, which can lead to injury.

Existing leashes that allow for extension of the leash upon an application of force, to reduce the effect of the first noted problem, result in other issues. A leash using an elastic cord, for example, may be ineffective in limiting an animal's movement in extreme circumstances, for example with large animals or when an animal is unusually excited.

Needs exist for improved leashes.

### SUMMARY

It is to be understood that both the following summary and the detailed description are exemplary and explanatory and are intended to provide further explanation of the invention as claimed. Neither the summary nor the description that follows is intended to define or limit the scope of the invention to the particular features mentioned in the summary or in the description. Rather, the scope of the invention is defined by the appended claims.

In certain embodiments, the disclosed embodiments may include one or more of the features described herein.

In various embodiments, a new apparatus provides for a leash that remains taut during use. The leash extends and contracts to reduce the problems associated with sudden forces transmitted to the leash, but avoids slack during the extension and contraction. The leash has a definite maximum length of extension, beyond which an animal cannot stretch the leash without breaking it. Elastic pull from the leash alerts a user and enables the user to react and hold onto the leash. Many accidents occur when a pet takes off unexpectedly, catching the walker off guard, and either the user is quickly pulled off balance and falls, and/or the pet escapes.

A new apparatus in various embodiments has a plurality of elements, including an elastic cord and a gliding buckle. The gliding buckle may be a plastic buckle that may have a first strap affixed to the gliding buckle and a second strap that loops through the gliding buckle. The gliding buckle may promote free movement of the second strap though the gliding buckle, allowing the second strap to pull easily through the gliding buckle. The elastic cord may be made of rubber and may be capable of stretching twice the length of the elastic cord. Additionally, the elastic cord may contain a knob on each end. The elastic cord may be connected to the second strap in two locations, wherein the knobs on each end of the elastic cord may connect to the second strap at two connectors on the second strap. Furthermore, the elastic leash may be offered with elastic cords of various length and thickness, making the leash capable of increasing and decreasing the tension depending on the size of the animal to which the elastic leash is attached.

A first strap may be fixedly connected to the gliding buckle at one end and may have a hook connected at the other end of the first strap. The hook may be made of plastic or metal, and may be a snap hook. Additionally, a second strap may be affixed at one end to the first strap. The second strap may have two connectors, which may be in the form of loops in the strap. The two connectors may hold the two knobs on the elastic cord, wherein the connector loops and knobs may be sized to prevent the knobs from sliding through the connector loops. The second strap may be looped through the gliding buckle so that the second strap may be capable of sliding through the gliding buckle freely. Moreover, a handle may be attached to one end of the second strap. The handle may be formed by creating a loop in the second strap, connecting the end of the second strap to itself. Furthermore, the handle may contain a cushioned grip that promotes comfort on the user's hand.

A new apparatus includes a leash having a first end for gripping and a second end for securing to an animal, a length of elastic material, and a length of inelastic material including first and second portions. The length of elastic material and length of inelastic material are configured such that application of tensile force to the first or second end of the leash extends the length of elastic material. That extension of the length of elastic material causes the first portion of the length of inelastic material to lengthen and the second portion of the length of inelastic material to correspondingly shorten. Contraction of the length of elastic material causes the second portion of the length of inelastic material to lengthen and the first portion of the inelastic material to correspondingly shorten, preventing slack in the leash upon sudden deapplication of a tensile force.

In embodiments, the leash may also include a sliding mechanism and an additional length of material. The sliding mechanism can be any device that a length of material can be put through that allows that material to slide back and forth through the device without falling out of the side of the device. Generally, a device having a rounded surface for smooth sliding and sides to contain the material is suitable. The additional length of material is fixedly secured to the sliding mechanism and the length of elastic material and length of inelastic material are formed in a loop and looped through the sliding element such that the length of inelastic material can slide through the sliding mechanism, while the length of elastic material cannot pass through the sliding element. For example, the elastic material may have a portion that is too large to fit through the sliding mechanism. Although the material is formed generally in a loop, that does not exclude offshoots or other parts, sections or connections that extend outside or inside of the loop. The first portion of the length of inelastic material extends between the sliding mechanism and one end of the length of elastic material, and the second portion of the length of inelastic material extends between the sliding mechanism and the other end of the length of elastic material. As the material slides back and forth through the sliding element, some of the material on one side of the sliding mechanism traverses to the other side, changing the relative lengths of the two portions.

In various embodiments, the sliding mechanism may be a gliding buckle. The apparatus may also include a direct connection between the additional length of material and the length of inelastic material, such as an additional connecting device or piece of material or integral section of one of the lengths of material. The length of elastic material may be an elastic cord attached to the length of inelastic material at its ends. The ends of the length of elastic material may be knob ends secured to the length of inelastic material by grommets in the length of inelastic material. The length of inelastic material may also include opposing small loops of material where the grommets are affixed. The first end may include a handle and a collar connector may be attached to the second end, which may be any kind of clip or other fastener that can be used to connect the apparatus to a pet collar or similar. The collar connector may be a snap hook. The handle may include a loop of material and may further include a hollow cylindrical cushioned grip wrapped around the loop of material, or in other embodiment may include various other types of handles, such as rigid handles, which may be secured to the first end in a variety of ways such as tying, stitching, etc.

In embodiments, the apparatus may include a direct connection between the additional length of material and the length of inelastic material, the sliding mechanism may be a gliding buckle, the length of elastic material may be an elastic cord having knob ends secured to the length of inelastic material by grommets affixed to opposing small loops of material in the length of inelastic material, the first end may also include a handle and a snap hook may be attached to the second end, and the handle may include a loop of material and a hollow cylindrical cushioned grip wrapped around the loop of material.

A new apparatus for an elastic leash includes a sliding mechanism, a first length of material fixedly secured to the sliding mechanism, and a second length of material formed in a loop and looped through the sliding element such that the second length of material can slide through the sliding mechanism. The second length of material has an elastic portion and the elastic portion cannot pass through the sliding element.

In various embodiments, the sliding mechanism may be a gliding buckle. There may be a direct connection between the additional length of material and the length of inelastic material. The length of elastic material may be an elastic cord attached to the length of inelastic material at its ends. The ends of the length of elastic material may be knob ends secured to the length of inelastic material by grommets. The first end may include a handle and a collar connector may be attached to the second end.

In a new elastic leash method, one end of a leash is pulled, thereby extending an elastic portion of the leash, pulling an inelastic portion of the leash through a sliding mechanism, and increasing the length of the leash, until no more of the inelastic portion of the leash can be pulled through the sliding mechanism, and tension on the leash is relaxed, thereby contracting the elastic portion of the leash, pulling an inelastic portion of the leash through the sliding mechanism in the opposite direction, and decreasing the length of the leash and preventing slack from developing in the leash.

In embodiments, pulling one end of a leash may include holding the end of the leash in place while an animal pulls on the other end, and relaxing tension on the leash may include reducing a force on the end of the leash as the animal stops pulling on the other end.

These and further and other objects and features of the invention are apparent in the disclosure, which includes the above and ongoing written specification, with the drawings.

### BRIEF DESCRIPTION OF THE DRAWINGS

The accompanying drawings, which are incorporated herein and form a part of the specification, illustrate exemplary embodiments and, together with the description, further serve to enable a person skilled in the pertinent art to make and use these embodiments and others that will be apparent to those skilled in the art. The invention will be more particularly described in conjunction with the following drawings wherein:

FIG. 1 shows a perspective view of one embodiment of an unextended elastic leash.

FIG. 2 shows a detail perspective view of the gliding buckle and elastic cord.

FIG. 3 shows a detail perspective view of the handle and elastic cord unextended.

FIG. 4 shows a enlarged detail view of the gliding buckle.

FIG. 5 shows a detail perspective view of the handle and elastic cord partially extended.

FIG. 6 shows a perspective view of elastic cord and straps being extended.

FIG. 7 shows a perspective view of the elastic leash extended.

### DETAILED DESCRIPTION

A new elastic leash will now be disclosed in terms of various exemplary embodiments. This specification discloses one or more embodiments that incorporate features of the invention. The embodiment(s) described, and references in the specification to “one embodiment”, “an embodiment”, “an example embodiment”, etc., indicate that the embodiment(s) described may include a particular feature, structure, or characteristic. Such phrases are not necessarily referring to the same embodiment. When a particular feature, structure, or characteristic is described in connection with an embodiment, persons skilled in the art may affect such feature, structure, or characteristic in connection with other embodiments whether or not explicitly described.

In the several figures, like reference numerals may be used for like elements having like functions even in different drawings. The embodiments described, and their detailed construction and elements, are merely provided to assist in a comprehensive understanding of the invention. Thus, it is apparent that the present invention can be carried out in a variety of ways, and does not require any of the specific features described herein. Also, well-known functions or constructions are not described in detail since they would obscure the invention with unnecessary detail.

The description is not to be taken in a limiting sense, but is made merely for the purpose of illustrating the general principles of the invention, since the scope of the invention is best defined by the appended claims.

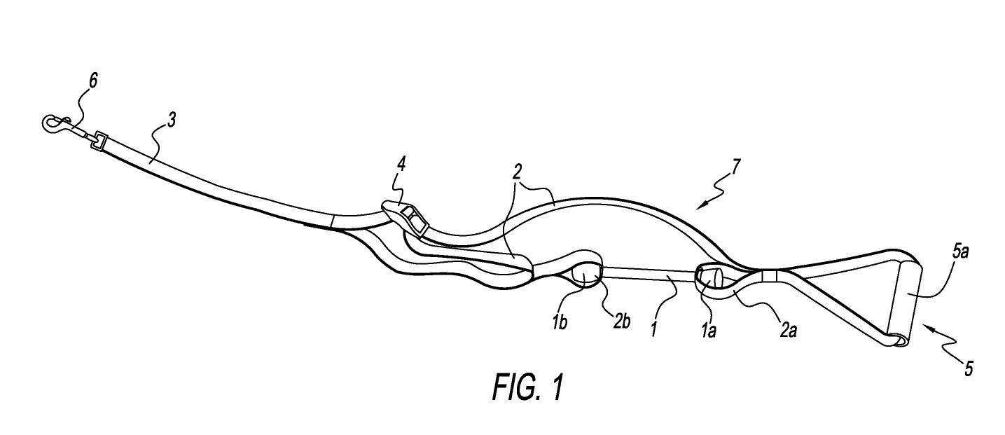

An embodiment of the present invention is illustrated in FIG. 1. FIG. 1 is a perspective view of an unextended elastic leash 7. The elastic leash 7 contains an elastic cord 1, a first strap 3, and a second strap 2. The first strap 3 is fixedly connected at one end to the gliding buckle 4. The first strap 3 contains a snap hook 6 attached at the end opposite to the end fixedly connected to the gliding buckle 4. The second strap 2 is affixed at one end to the first strap 3 and is looped through the gliding buckle 4. At the other end of the second strap 2 is a handle 5 with a cushioned grip 5a.

Furthermore, the second strap 2 contains a first loop connector 2a and a second loop connector 2b, with second loop connector 2b positioned on second strap 2 between the end of second strap 2 affixed to first strap 3 and the gliding buckle 4. First loop connector 2a is positioned adjacent to handle 5. The first loop connector 2a and the second loop connector 2b are formed from loops made in the second strap 2. Stretched between the first loop connector 2a and the second loop connector 2b is an elastic cord 1. The elastic cord 1 contains a first knob 1a and a second knob 1b. The first knob 1a interacts with the first loop connector 2a, where the first knob 1a is sized to prevent the first knob 1a from sliding through the first loop connector 2a, locking first knob 1a within first loop connector 2a. The second knob 1b interacts with the second loop connector 2b, where the second knob 1b is sized to prevent the second knob 1b from sliding through the second loop connector 2b, locking second knob 1b within second loop connector 2b.

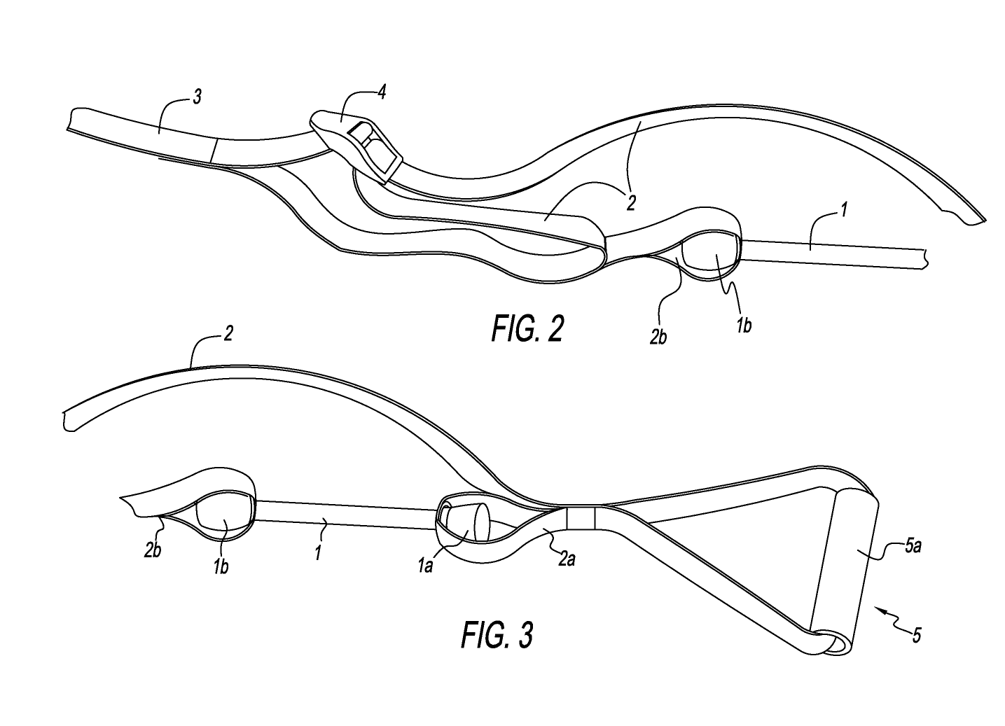

FIG. 2 shows a perspective detail view of the gliding buckle 4 and elastic cord 1. In FIG. 2 it can be seen that first strap 3 is fixedly attached to part of gliding belt 4. It can also be seen that second strap 2 loops through gliding buckle 4 and contains a second loop connector 2b positioned along second strap 2 between gliding buckle 4 and the end of second strap 2 affixed to first strap 3. Furthermore, gliding buckle 4 is configured in a way for second strap 2 to slide freely through gliding buckle 4. Second knob 1b is configured to a size to prevent second knob 1b from sliding out of second loop connector 2b. The interaction between second knob 1b and second loop connector 2b, along with the positioning of second loop connector 2b on second strap 2 promotes a relationship between second strap 2 and elastic cord 1, such that when elastic cord 1 is extended, second strap 2 glides through gliding buckle 4, increasing the length of second strap 2 between gliding buckle 4 and handle 5.

FIG. 3 shows a perspective detail view of the handle 5 and elastic cord 1 unextended. From FIG. 3 it can be seen that handle 5 is configured by looping the end of second strap 2 and connecting that end of second strap 2 to itself, in this embodiment by stitching. Moreover, handle 5 contains a cushioned grip 5a, which is a hollow cylinder that wraps around the portion of second strap 2 that makes up handle 5. First knob 1a is configured to a size to prevent first knob 1a from sliding out of first loop connector 2a. Similarly, second knob 1b is configured to a size to prevent second knob 1b from sliding out of second loop connector 2b. These configurations of first knob 1a, second knob 1b, first loop connector 2a, and second loop connector 2b, along with the positioning of second loop connector 2b, promote the relationship between second strap 2 and elastic cord 1.

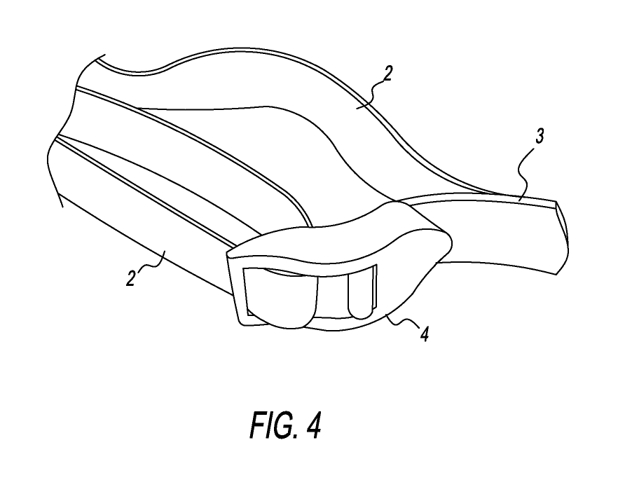

FIG. 4 shows an enlarged detail view of the gliding buckle 4. FIG. 4 demonstrates how first strap 3 is fixedly attached to part of gliding belt 4. Furthermore, second strap 2 loops through gliding buckle 4, and gliding buckle 4 is configured in a way for second strap 2 to slide freely through gliding buckle 4.

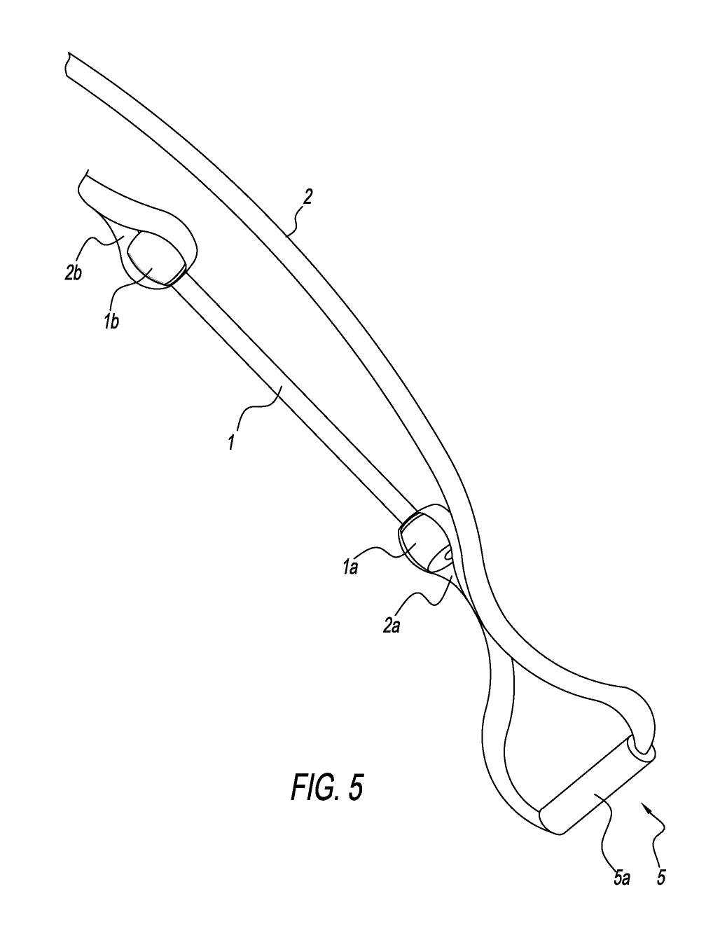

FIG. 5 shows a perspective detail view of the handle 5 and elastic cord 1 extended. FIG. 5 illustrates that handle 5 is configured by looping the end of second strap 2 and connecting the end of second strap 2 to itself. Moreover, handle 5 contains a cushioned grip 5a, which is a hollow cylinder wrapped around the portion of second strap 2 that forms handle 5. Furthermore, when elastic cord 1 is extended, first knob 1a and second knob 1b interact with first loop connector 2a and second loop connector 2b to hold elastic cord 1 in place between first loop connector 2a and second loop connector 2b, facilitating the relationship between elastic loop 1 and second strap 2.

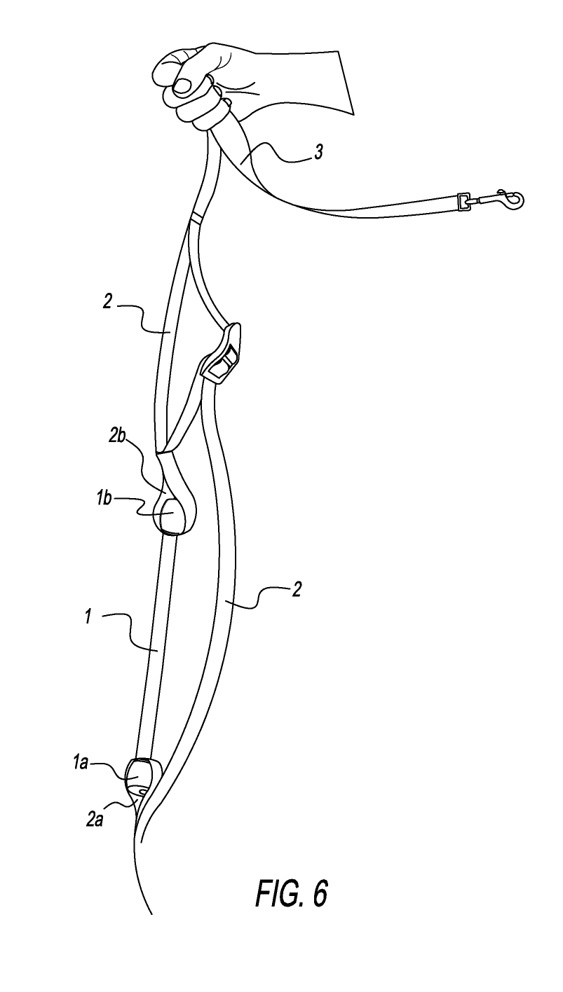

FIG. 6 shows an enlarged view of elastic cord 1 and second strap 2 being extended. When a force is exerted on first strap 3, for example pulling, as can be seen in FIG. 6, elastic cord 1 extends, and second strap 2 is pulled through gliding buckle 4. As first strap 3 is being pulled, the pulling force transfers through to the end of second strap 2 that is connected to first strap 3, resulting in second strap 2 being pulled concurrently.

Because second loop connector 2b is positioned between the end of second strap 2 that is connected to first strap 3 and the gliding buckle 4, the pulling on first strap 3 results in second loop connector 2b being pulled in the same direction as first strap 3. Because of the interconnection of second loop connector 2b and second knob 1b, and interconnection of first loop connector 1a and first knob 1a, the pulling on first strap 3 facilitates the pulling of second loop connector 2b away from first loop connector 2a, resulting in the extension of elastic cord 1. Furthermore, because of the positioning of second loop connector 2b on second strap 2, as second loop connector 2b is pulled away from first loop connector 2a, second strap 2 is pulled through gliding buckle 4, increasing the length of second strap 2 between the gliding buckle 4 and handle 5.

When buckle 4 reaches second loop connector 2b, no more of the second strap 2 can be pulled through the buckle 4 and the leash is fully extended. This provides a maximum length for the leash, giving a user certainty that an animal will not be able to get further than this maximum length away from the user, even when the animal is large or excited. When the leash is in an extended position and the force on the leash is reduced or stopped, the force generated by the elastic cord 1 on loop connectors 2a, 2b pulls second strap 2 back through the buckle 4 as the elastic cord 1 contracts, preventing slack from developing in the leash.

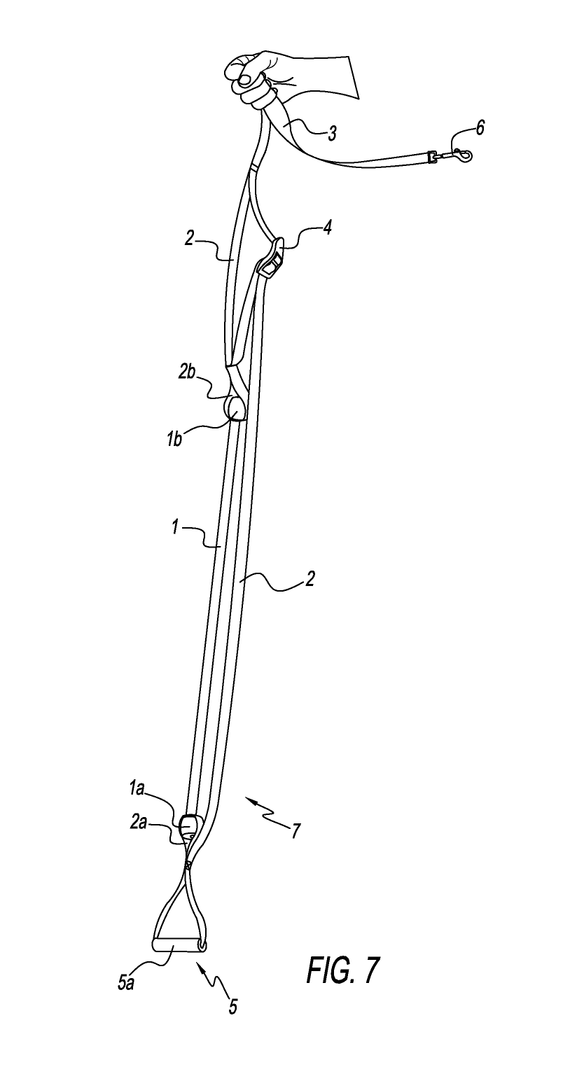

FIG. 7 shows a perspective view of the elastic leash 7 with elastic cord 1 being extended. FIG. 7 demonstrates the same mechanism as described above for FIG. 6, but illustrates further extension and the snap hook 6 attached to the end of first strap 3 and handle 5, with cushioned grip 5a, formed from looping the end of second strap 2 to itself.

Various cords having various materials and thicknesses can be used depending on the desired resistance. For preventing sudden application of force to a user or animal, a cord with greater resistance is desirable for larger animals, while a cord with less resistance is desirable for smaller animals.

The invention is not limited to the particular embodiments illustrated in the drawings and described above in detail. Those skilled in the art will recognize that other arrangements could be devised, for example, using various leash materials, connections, and configurations utilizing similar principles. Various mechanisms other than a gliding belt can be used to serve a similar purpose in the invention. The invention encompasses every possible combination of the various features of each embodiment disclosed. While the invention has been described with reference to specific illustrative embodiments, modifications and variations of the invention may be constructed without departing from the spirit and scope of the invention as set forth in the following claims.

I claim:

1. An apparatus, comprising:
a leash comprising a first end for gripping and a second end for securing to an animal, a length of elastic material, and a length of inelastic material comprising first and second portions;
wherein the length of elastic material and length of inelastic material are configured such that application of tensile force to the first or second end of the leash extends the length of elastic material, such that extension of the length of elastic material causes the first portion of the length of inelastic material to lengthen and the second portion of the length of inelastic material to correspondingly shorten, and such that contraction of the length of elastic material causes the second portion of the length of inelastic material to lengthen and the first portion of the inelastic material to correspondingly shorten, whereby slack in the leash is prevented upon sudden deapplication of a tensile force.

2. The apparatus of claim 1, wherein the leash further comprises a sliding mechanism and an additional length of material, wherein the additional length of material is fixedly secured to the sliding mechanism and the length of elastic material and length of inelastic material are formed in a loop and looped through the sliding element such that the length of inelastic material can slide through the sliding mechanism, wherein the length of elastic material cannot pass through the sliding element, and wherein the first portion of the length of inelastic material extends between the sliding mechanism and one end of the length of elastic material, and the second portion of the length of inelastic material extends between the sliding mechanism and the other end of the length of elastic material.

3. The apparatus of claim 1, wherein the sliding mechanism is a gliding buckle.

4. The apparatus of claim 1, further comprising a direct connection between the additional length of material and the length of inelastic material.

5. The apparatus of claim 1, wherein the length of elastic material is an elastic cord attached to the length of inelastic material at its ends.

6. The apparatus of claim 4, wherein the ends of the length of elastic material are knob ends and are secured to the length of inelastic material by grommets.

7. The apparatus of claim 5, wherein the length of inelastic material further comprises opposing small loops of material where the grommets are affixed.

8. The apparatus of claim 1, wherein the first end comprises a handle and a collar connector is attached to the second end.

9. The apparatus of claim 7, wherein the collar connector is a snap hook.

10. The apparatus of claim 7, wherein the handle comprises a loop of material.

11. The apparatus of claim 9, wherein the handle further comprises a hollow cylindrical cushioned grip wrapped around the loop of material.

12. The apparatus of claim 2, further comprising a direct connection between the additional length of material and the length of inelastic material, wherein the sliding mechanism is a gliding buckle, wherein the length of elastic material is an elastic cord comprising knob ends secured to the length of inelastic material by grommets affixed to opposing small loops of material in the length of inelastic material, wherein the first end further comprises a handle and a snap hook is attached to the second end, wherein the handle comprises a loop of material and a hollow cylindrical cushioned grip wrapped around the loop of material.

13. An apparatus for an elastic leash, comprising:
a sliding mechanism;
a first length of material fixedly secured to the sliding mechanism; and
a second length of material formed in a loop and looped through the sliding element such that the second length of material can slide through the sliding mechanism;
wherein the second length of material comprises an elastic portion;
wherein the elastic portion cannot pass through the sliding element.

14. The apparatus of claim 13, wherein the sliding mechanism is a gliding buckle.

15. The apparatus of claim 13, further comprising a direct connection between the additional length of material and the length of inelastic material.

16. The apparatus of claim 13, wherein the length of elastic material is an elastic cord attached to the length of inelastic material at its ends.

17. The apparatus of claim 16, wherein the ends of the length of elastic material are knob ends and are secured to the length of inelastic material by grommets.

18. The apparatus of claim 13, wherein the first end comprises a handle and a collar connector is attached to the second end.

19. An elastic leash method, comprising:
pulling one end of a leash, thereby extending an elastic portion of the leash, pulling an inelastic portion of the leash through a sliding mechanism, and increasing the length of the leash, until no more of the inelastic portion of the leash can be pulled through the sliding mechanism; and
relaxing tension on the leash, thereby contracting the elastic portion of the leash, pulling an inelastic portion of the leash through the sliding mechanism in the opposite direction, and decreasing the length of the leash and preventing slack from developing in the leash.

20. The elastic leash method of claim 19, wherein pulling one end of a leash comprises holding the end of the leash in place while an animal pulls on the other end, and wherein relaxing tension on the leash comprises reducing a force on the end of the leash as the animal stops pulling on the other end.
